(19) United States
(12) Patent Application Publication
(10) Pub. No.: US 2012/0004942 A1
(43) Pub. Date: Jan. 5, 2012

(54) Conflict Resolution in a Computerized Calendaring System

(75) Inventors: Sean Callanan, Dublin (IE); Ruthie D. Lyle, Durham, NC (US); Patrick Joseph O'Sullivan, Ballsbridge (IE); Fred Raguillat, Dunboyne (IE); Carol Sue Zimmet, Boxborough, MA (US)

(73) Assignee: INTERNATIONAL BUSINESS MACHINES CORPORATION, Armonk, NY (US)

(21) Appl. No.: 12/827,653

(22) Filed: Jun. 30, 2010

(51) Int. Cl. G06Q 10/00

(52) U.S. Cl. 705/7.22

(57) ABSTRACT

Conflict resolution in a computerized calendaring system executed by a processor includes: with the processor, receiving a request to schedule a new event that conflicts with a previously scheduled event; determining with the processor that the previously scheduled event has priority over the new event based on historical event data; and imposing with the processor a constraint on scheduling the new event according to a defined priority policy.

### BACKGROUND

Aspects of the present invention relate to computerized calendaring systems. More specifically, aspects of the present invention relate to the resolution of conflicts arising within a computerized calendaring system.

Meetings, appointments, and other scheduled events often play an integral role in how a person allocates his or her time. Many calendaring solutions exist to facilitate the effective organization and management of time. For example, various computer applications exist that allow a user to dynamically create or alter scheduled events, view a consolidated schedule of planned events, and provide interactive reminders of pending scheduled events. Server-based calendaring systems have become particularly popular among corporations and other organizations due to the fact that server-based calendaring systems enable collaborative calendaring among multiple users.

In a typical server-based calendaring system, one or more servers maintain calendaring data for multiple users. The users access this calendaring data through client applications installed on devices that communicate with the server(s). Using this infrastructure, a user may request that an event be scheduled in the calendaring system that designates one or more potential event attendees. For each potential event attendee that accepts the invitation, a scheduled event will be automatically created in the potential attendee's individual calendar, and the time period associated with the newly scheduled event may be marked as unavailable to any other user attempting to schedule that same potential attendee for an overlapping block of time.

### BRIEF SUMMARY

A method of conflict resolution in a computerized calendaring system executed by a processor includes: with the processor, receiving a request to schedule a new event that conflicts with a previously scheduled event; determining with the processor that the previously scheduled event has priority over the new event based on historical event data; and imposing with the processor a constraint on scheduling the new event according to a defined priority policy.

A method of conflict resolution in a computerized calendaring system executed by a processor includes: with the processor, determining that a first future event and a second future event share a common time period and a common attendee; determining with the processor that the first future event has priority to the common attendee for the common time period based on historical event data; and imposing a constraint on scheduling the common attendee for the second future event according to a defined priority policy.

A system includes a processor; and a memory communicatively coupled to the processor. The memory has executable code stored thereon such that the processor, upon executing the executable code, is configured to: receive a request to schedule a new event that conflicts with a previously scheduled event; determine that the previously scheduled event has priority over the new event based on historical event data; and impose a constraint on scheduling the new event according to a defined priority policy.

A computer program product for conflict resolution in a computerized calendaring system includes a computer readable storage medium having computer readable program code embodied therewith. The computer readable program code includes: computer readable program code configured to receive a request to schedule a new event that conflicts with a previously scheduled event; computer readable program code configured to determine that the previously scheduled event has priority over the new event based on historical event data; and computer readable program code configured to impose a constraint on scheduling the new event according to a defined priority policy.

### BRIEF DESCRIPTION OF THE SEVERAL VIEWS OF THE DRAWINGS

The accompanying drawings illustrate various embodiments of the principles described herein and are a part of the specification. The illustrated embodiments are merely examples and do not limit the scope of the claims.

FIG. 1 is a block diagram of an illustrative computerized calendaring system, according to one exemplary embodiment of principles described herein.

FIG. 2 is a diagram of an illustrative functionality of a computerized calendaring system, according to one exemplary embodiment of principles described herein.

FIG. 3 is a flowchart diagram of an illustrative method of conflict resolution in a computerized calendaring system, according to one exemplary embodiment of principles described herein.

FIG. 4 is a flowchart diagram of an illustrative method of conflict resolution in a computerized calendaring system, according to one exemplary embodiment of principles described herein.

FIGS. 5A-5C are flowchart diagrams of illustrative priority policies implemented by a computerized calendaring system, according to one exemplary embodiment of principles described herein.

FIG. 6 is a diagram of an illustrative user interface window of a computerized calendaring system for initiating a new event, according to one exemplary embodiment of principles described herein.

FIGS. 7A-7C are diagrams of illustrative user interface window of a computerized calendaring system after a conflict has been detected, according to one exemplary embodiment of principles described herein.

FIG. 8 is a diagram of an illustrative user interface window of a computerized calendaring system for determining attendee availability in scheduling an event, according to one exemplary embodiment of principles described herein.

Throughout the drawings, identical reference numbers designate similar, but not necessarily identical, elements.

### DETAILED DESCRIPTION

The present specification discloses methods and systems for conflict resolution in a computerized calendaring system. In these methods and systems, a computerized calendaring system receives a request to schedule a new event that conflicts with a previously scheduled event; determines that the previously scheduled event has priority over the new event based on historical event data; and imposes a constraint on scheduling the new event according to a defined priority policy.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

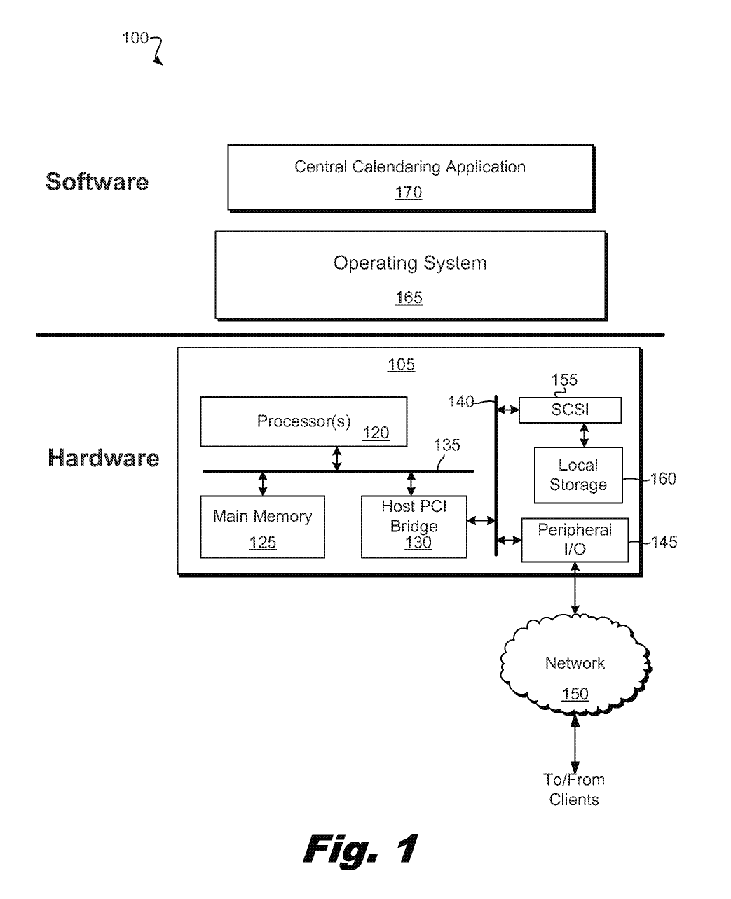

With reference now to FIG. 1, a block diagram is shown of an illustrative computing system (100) acting as a server in a server-based calendaring system. However, it will be readily apparent to those having skill in the art that the illustrative computing system (100) may also be used to implement a client device that communicates with a server in a server-based calendaring system. In still other examples, the illustrative computing system (100) may implement the entire computerized calendaring system functionality such that the illustrative computing system (100) interacts directly with each user and maintains centralized calendaring data for each user.

The hardware platform (105) of the computing system (100) may include at least one processor (120) that executes code stored in the main memory (125). In certain embodiments, the processor (120) may be a multi-core processor having multiple independent central processing units (CPUs), with each CPU having its own L1 cache and all CPUs sharing a common bus interface and L2 cache. Alternatively, the processor (120) may be a single-core processor.

The at least one processor (120) may be communicatively coupled to the main memory (125) of the hardware platform and a host peripheral control interface bridge (PCI) (130) through a main bus (135). The main memory (125) may include, for example, dynamic non-volatile memory, such as random access memory (RAM). The main memory (125) may store executable code and data that is obtainable by the processor (120) through the main bus (135).

The host PCI bridge (130) may act as an interface between the main bus (135) and a peripheral bus (140) used to communicate with peripheral I/O devices (145). Among these peripheral devices may be a network interface card configured to communicate with an external network (150), external human interface devices (e.g., monitor, keyboard, mouse, touch screen, speaker, microphone), other external devices (e.g., external storage, dongles, specialized tools), serial buses (e.g., Universal Serial Bus (USB)), and the like. A Small Computer System Interface (SCSI) (155) for communicating with local storage devices (160) may also communicate with the peripheral bus (140).

In cases where the illustrative computing system (100) is configured to act as a server in a server-based calendaring system, as shown in FIG. 1, the external network (150) may communicatively couple the illustrative computing system (100) to client devices, through which individual users of the calendaring system may communicate with the illustrative computing system (100). Examples of such client devices include, but are not limited to, desktop computers, laptop computers, tablet computers, PDAs, mobile telephones, and any other suitable electronic device for communicating with a computerized calendaring system over a network or direct line.

It will be readily apparent to those having skill in the art that the present configuration of the hardware platform (105) is merely illustrative of one type of hardware platform (105) that may be used in connection with the principles described in the present specification. Moreover, it will be further apparent that various modifications, additions, and deletions to the hardware platform (105) shown are conceivable and anticipated by the present specification.

The hardware platform (105) shown in the lower half of the diagram of FIG. 1 is configured to implement the elements of software functionality shown in the upper half of the diagram of FIG. 1. Thus, as shown in FIG. 1, an operating system (165) program is executed directly by the hardware platform (105). The operating system (165) includes at least a kernel and a user interface. The kernel is the core of the operating system (165) in that the kernel provides the lowest level of abstraction in the software functionality of the operating system (165). The kernel may interact with and manage the performance of hardware resources in the hardware platform (105), including the processor(s) (120), the main memory (125), and the peripheral devices. In the present example, the illustrative computing system (100) is configured to execute a central calendaring application (170). Thus, the kernel of the operating system (165) controls the execution of central calendaring application (170) by the processor(s) (120).

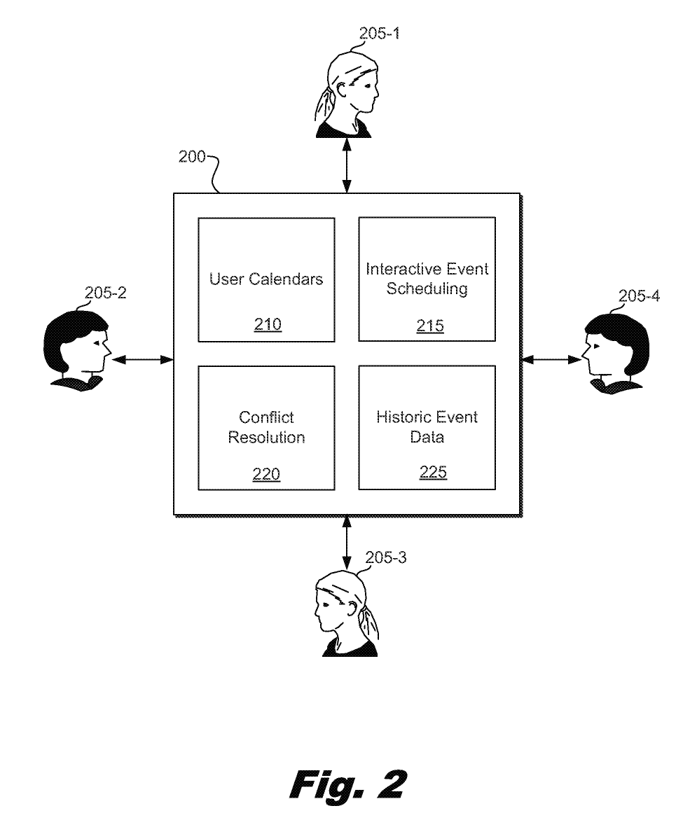

FIG. 2 shows one example of the functionality implemented by a computerized calendaring system (200). As described previously, this functionality may be implemented by one or more servers working in combination with one or more client devices, by a server alone, or by a standalone computing device. For example, the computerized calendaring system (200) shown in FIG. 2 may be implemented at least in part by the central calendaring application (170, FIG. 1) described in conjunction with the illustrative computing system (100, FIG. 1) of FIG. 1.

The computerized calendaring system (200) is configured to interact with multiple users (205-1 to 205-4), maintaining individual user calendars (210) for each user (205-1 to 205-4). The individual user calendar (210) for a user (205-1) may include, among other items, future events scheduled by the user (205-1) personally, future events scheduled by other users (205-2 to 205-4) for which the user (205-1) is a designated attendee, events scheduled automatically by the computerized calendaring system (200) according to organizational policy, tasks to be completed by the user (205-1), and the like.

An interactive event scheduling module (215) implemented by the computerized calendaring system (200) facilitates the scheduling of events among the multiple users (205-1 to 205-4). For example, a user (205-1) may request that the computerized calendaring system schedule a new event and invite one or more designated attendees to the scheduled event.

In previous calendaring systems, an event initiator may be able to view the availability of one or more designated attendees in selecting a block of time for the requested scheduled event. Nevertheless, due to the complexity of busy schedules and different time zones, an event initiator in such systems will, at times, schedule a new event regardless of a conflict with a previously existing event. Often by scheduling the new event the meeting initiator may interfere with a long-standing recurring meeting or disrupt a previously scheduled meeting that has more value than the new meeting.

To address these issues, the computerized calendaring system (200) disclosed herein utilizes a conflict resolution module (220) that arbitrates between a conflicting new meeting request and a previously scheduled event or previously received event request. The conflict resolution module (220) works on the basis of variable priority from the perspective of event invitees and event inviters. By determining which of the new meeting request and the previously scheduled event or previously receive event request has greater priority, the conflict resolution module (220) improves the quality of the scheduled events in individual user calendars (210) and reduces the amount of time spent on manually rescheduling conflicting events.

In particular, where a new event request conflicts with a previously scheduled event or a previously received event request, the conflict resolution module (220) makes a priority determination based on historical event data (225) stored by the computerized calendaring system. By analyzing the historical event data (225), the conflict resolution module (220) may determine whether the previously scheduled event or the new event request has established more entitlement to a conflicted block of time, invited attendee, or resource. This historical event data (225) may be particularly relevant in cases where at least the previously scheduled event or event request is a recurring event such that the computerized calendaring system (200) has tracked data for past occurrences of the event.

As used in the present specification and in the appended claims, the term “recurring event” refers to an event for which multiple past occurrences exist or for which multiple future occurrences are anticipated. The various occurrences of a recurring event may be held regularly, but such regularity is not necessary for an event to be considered “recurring” in the present specification and claims. For example, a recurring event may exist where multiple meetings have occurred on the same topic with substantially the same attendees, regardless of whether the meetings are scheduled regularly or on an “as needed” basis.

Many different types of historical event data (225) may be tracked and stored by the computerized calendaring system (200) for the purpose of determining priority between conflicting event requests or an event request that conflicts with a previously scheduled event. Examples of such historical event data (225) include, but are not limited to, a) a number of occurrences that have been held to date of a recurring scheduled event; b) a number of remaining scheduled occurrences for a recurring scheduled event; c) historical attendance rates for past occurrences of a recurring scheduled event; d) a historical attendance rate associated with one or more specific attendees of the recurring scheduled event, e) a degree of success associated with one or more past occurrences of a recurring scheduled event, f) a measured difficulty associated with scheduling past occurrences of a recurring scheduled event, and the like.

The priority determination may be made on the basis of policies defined within the calendaring systems. Examples of such policies may include, but are not limited to, giving preference to an event based on whether the event is a one-time event or a recurring event, giving preference to a recurring event based on a number of previous occurrences, giving preference to a recurring event based on a regular schedule associated with the event, giving preference to an event that is statistically more likely to be successful in terms of attendance, giving preference to an event that is statistically more likely to be successful in terms of reaching a goal, giving preference to an event giving preference to an event based on how difficult it would be to reschedule the event, and the like.

In certain examples, the computerized calendaring system may enforce only one policy in arbitrating a dispute between two conflicting events. In other examples, the computerized calendaring system may enforce multiple policies concurrently such that the ultimate determination of priority is based on the weighted scoring of multiple policies. For instance, in one dispute the concept of scoring probabilities may be used to evaluate a) the probability of attendance associated with each event, b) the probability that each event can be successfully rescheduled, and c) the probability that each event will have a successful outcome. Each of these probabilities may be weighted and scored consistent with the policies selected for the computerized calendaring system to determine which of the two events has priority.

For example, consider the scenario where a first user (205-1) schedules a recurring weekly meeting for a group of people that includes the second and third users (205-2, 205-3), which is successfully held for a period of several weeks. If a fourth user (205-4) then tries to schedule the second user (205-2) for a new meeting that conflicts with the previously scheduled recurring weekly meeting, the conflict resolution module (220) may determine that the previously scheduled recurring weekly meeting has priority over the new meeting based on tracked historical event data (225) indicating that based on precedent, the previously scheduled recurring weekly meeting has more entitlement to the conflicted time slot than the new meeting.

In another example, a first user (205-1) has scheduled and successfully held many meetings involving the second and third users (205-2, 205-3) on a first topic, but the meetings have not been held on a regularly scheduled basis. If the fourth user (205-4) then tries to schedule the second user (205-2) for a new meeting on a second topic for which no meetings have been previously held, the conflict resolution module (220) may determine that a meeting scheduled by the first user (205-1) involving the second and third users (205-2, 205-3) on the first topic that conflicts with the new meeting has priority over the new meeting. This determination may be made based at least partially on the fact that the first user has successfully developed a historical precedent for meetings on the first topic involving the second and third users (205-2, 205-3).

In certain examples, a computerized calendaring system (200) may be configured to determine whether a previously scheduled event or a new meeting request is a recurring event based on a semantic analysis of the scheduled event or new meeting request in conjunction with the historical event data (225). This analysis may search for commonalities in subject matter and/or attendees between the scheduled event or new meeting request and stored historical event data (225). In other examples, the computerized calendaring system (200) may be configured to automatically organize recurring events as such.

Additionally, non-historical factors may also be used in the determination of priority between a new event request and a previously scheduled event or a previously received event request. Examples of such factors include, but are not limited to, a) a seniority associated with one or more tentative attendees of a scheduled event or a requested event, b) a respective perceived difficulty in rescheduling each conflicting scheduled event or requested event, c) a respective anticipated level of success associated with each conflicting scheduled event or requested event, and the like.

Once the conflict resolution module (220) has assigned priority to either a previously scheduled event (or previously scheduled event request) or a conflicting new event request, the conflict resolution module (220) may impose constraints on the scheduling of the lower-priority scheduled event or event request. These constraints may be determined based on predefined policy. In some examples, the predefined a single constraint or set of constraints imposed on each lower-priority conflicting scheduled event or event request. In other examples, the priority policy may define various constraints according to, for example, a level of priority discrepancy between a lower-priority scheduled event or event request and a higher-priority scheduled event or event request. In these examples, the conflict resolution module (220) may assign a priority score to each conflicting scheduled event or event request to determine the appropriate constraint to impose on the lower-priority scheduled event or event request.

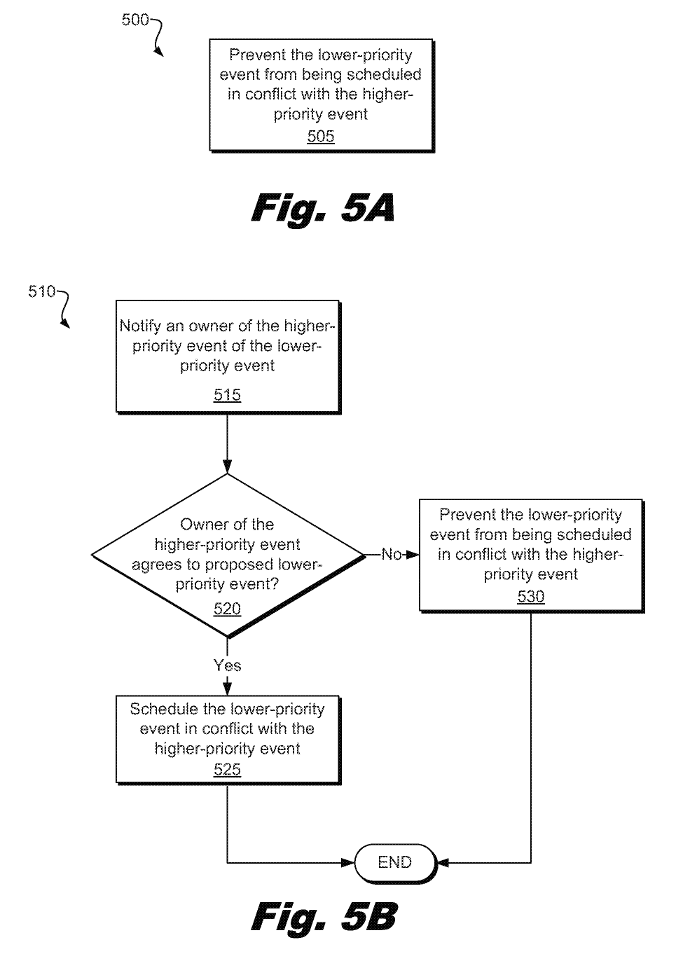

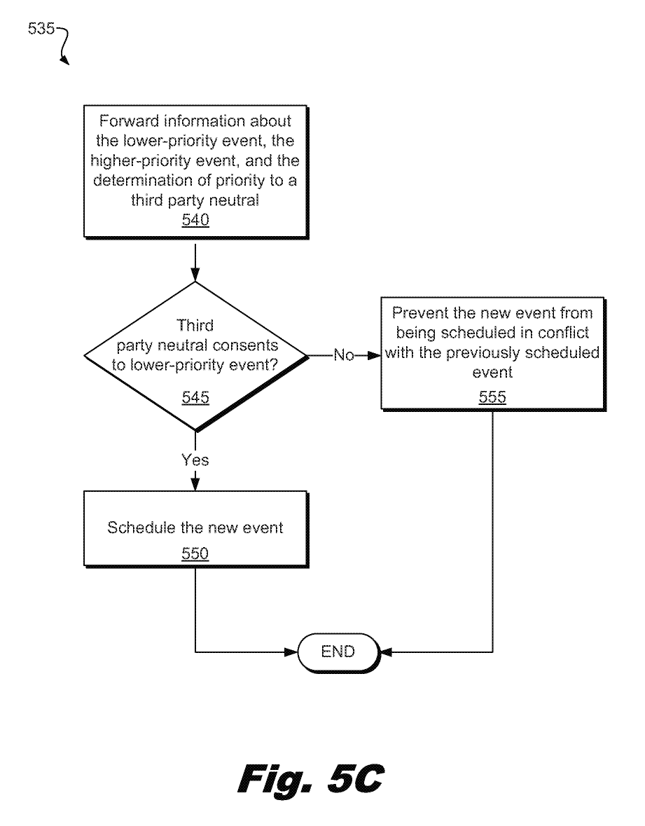

Examples of scheduling constraints that may be imposed by the computerized calendaring system (200) on a lower-priority conflicting scheduled event or event request include, but are not limited to: a) preventing the lower-priority event or event request from being scheduled in conflict with the higher-priority scheduled event or event request outright, and b) requiring the consent of an owner of the higher-priority event or event request and/or a neutral third party before allowing the lower-priority event or event request to be scheduled in conflict with the higher-priority scheduled event. These exemplary constraints are described in more detail with reference to FIGS. 5A-5C below.

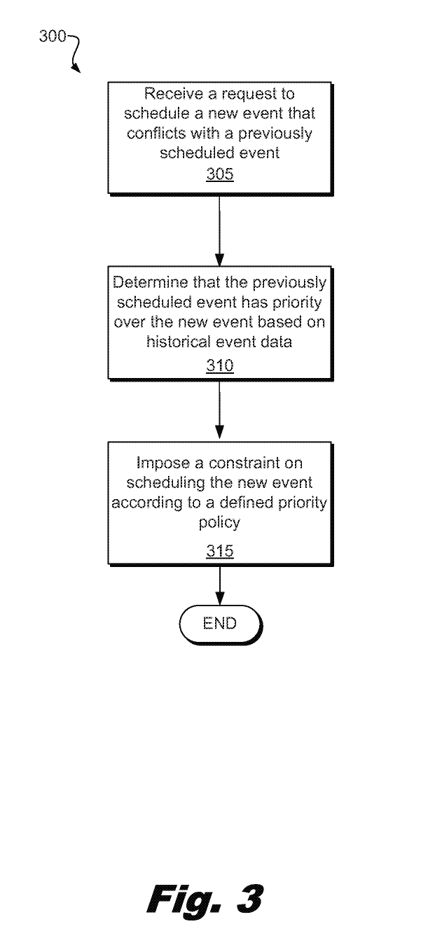

Referring now to FIG. 3, a flowchart diagram is shown of an illustrative method (300) of resolving conflicts performed by a computerized calendaring system, such as the computerized calendaring system (200) shown in FIG. 2 as implemented by one or more computing systems (100, FIG. 1). As shown in FIG. 3, the illustrative method (300) includes receiving (step 305) a request to schedule a new event that conflicts with a previously scheduled event. The conflict between the new event and the previously scheduled event may involve a block of time, meeting attendee, or resource required by both the new event and the previously scheduled event. The computerized calendaring system may then determine (step 310) that the previously scheduled event has priority over the new event based on historical event data, as described above. Finally, the system may impose (step 315) a constraint on scheduling the new event according to a defined priority policy.

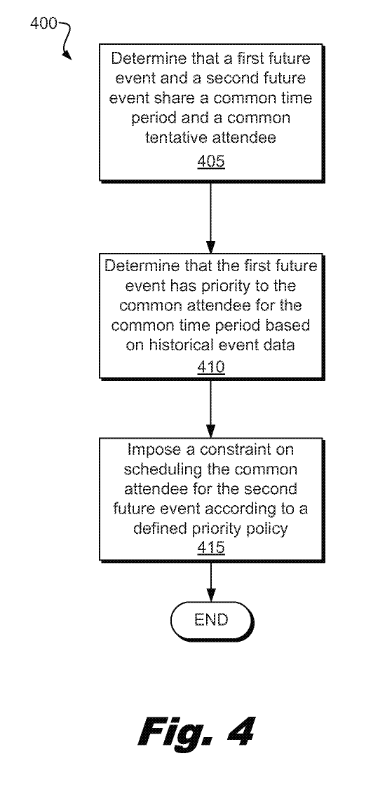

Referring now to FIG. 4, a flowchart diagram is shown of another illustrative method (400) of conflict resolution in a computerized calendaring system, such as the computerized calendaring system (200) shown in FIG. 2 as implemented by one or more computing systems (100, FIG. 1). As shown in FIG. 4, the method (400) includes determining (step 405) that a first future event and a second future event share a common time period and a common tentative attendee. Such a determination indicates the existence of a conflict between the first future event and the second future event. It is then determined (step 410) that the first future event has priority to the common attendee for the common time period based on historical event data, as described above. For example, it may be determined that the first future event has, by historical precedent, established a prevailing right to the common attendee for the common time period over the second future event. Upon making such a determination, the computerized calendaring system may impose (step 415) a constraint on scheduling the common attendee for the second future event according to a defined policy. Examples of such policy considerations are described above with respect to FIG. 2.

Referring now to FIGS. 5A-5C, various illustrative constraints are described which may be imposed on a scheduled event or event request that has a lower determined priority than a conflicting scheduled event or event request. It bears repeating that different priority policies enforced by different computerized calendaring systems may enforce different constraints or use differing criteria to determine which constraints are imposed. Any such policy/constraint combination that may suit a particular application of the principles described herein may be used.

Furthermore, it should be understood that other constraints beyond those described in the present specification will be readily apparent to those having skill in the relevant art. Such constraints are contemplated within the scope of the present specification.

FIG. 5A illustrates a constraint (500) in which a lower-priority event or event request is completely prevented (step 505) from being scheduled in conflict with the higher-priority event or event request.

FIG. 5B illustrates a constraint process (510) in which an owner or organizer of the higher-priority event or must consent to the conflicting lower-priority event before the lower-priority event may be scheduled in conflict with the higher-priority event. As such, the owner or organizer of the higher-priority event or event request must be notified (step 515) of the existence and details of the lower-priority event or event request. This notification may occur as an email, pop-up screen, or similar electronic message to the owner or organizer of the higher-priority event which solicits the consent of the owner or organizer of the higher-priority event. If the owner/organizer of the previously scheduled event agrees (determination 520, Yes) to the proposed lower-priority event being scheduled in conflict with the higher-priority event, the lower-priority event is scheduled (step 525) in conflict with the higher-priority event as proposed. Otherwise, (determination 520, No), the lower-priority event may be prevented (step 530) from being scheduled in conflict with the higher-priority event.

FIG. 5C illustrates a constraint process (535) through which the consent of a neutral third-party is sought prior to the lower-priority event being scheduled in conflict with the higher-priority event. This constraint process (535) may be executed as a matter of default priority, or, alternatively, as a result of a failure to obtain the consent of the owner/organizer of the higher-priority event. In this constraint process (535), information about the lower-priority event and the higher-priority event is forwarded (step 540) to a third party neutral together with the determination of priority made by the computerized calendaring system.

The third party neutral may be a common acquaintance of both the owner of the lower-priority event and the owner of the higher-priority event and/or have a supervisory role. In certain examples, the third party neutral may be determined automatically by the computerized calendaring system by querying a directory, such as a Lightweight Directory Access Protocol (LDAP) directory available to the system available, over a network and/or a locally stored directory. Additionally or alternatively, relationship data between the owner of the lower-priority event and the owner of the higher-priority event in a social networking service may be used to select an appropriate third party neutral. For example, if user A and user B are the owners of the higher-priority and lower-priority events, respectively, a social networking service or directory may be queried to determine that user C is a supervisor of both user A and user B, and that user C would therefore be an appropriate third party neutral in determining whether user B may schedule the lower-priority event in conflict with the higher-priority event.

If the third party neutral consents (decision 545, Yes) to the lower-priority event being scheduled in conflict with the higher-priority event, the lower-priority event is scheduled (step 550) as proposed. Otherwise (decision 545, No), the lower-priority event is prevented (step 555) from being scheduled in conflict with the higher-priority event. A notification of the decision made by the third party neutral may be transmitted to both the owner of the higher-priority event and the owner of the lower-priority event through the computerized calendaring system.

In certain examples, the constraint process (535) of FIG. 5C may be modified to include a multi-tiered “escalation” approach to consent where a decision denying the lower-priority event permission to be scheduled in conflict with the higher-priority event may be appealed to various levels of authority. For example, authorities may be organized at a team level, a project level, a geography level, a division level, and the like. As permitted by the computerized calendaring system, the losing party in a calendaring dispute may appeal a decision to successively higher levels of authority until a final decision is made. In these examples, the extent to which a decision is appealed may be governed by the priority polic(ies) in place.

The constraints shown in FIGS. 5A-5C may be imposed separately or in combination, according to a particular policy. For example, a priority policy may dictate that for cases where a lower priority disparity exists, the lower-priority scheduled event or event request may be scheduled in conflict with the higher-priority scheduled event or event request if consent is received from an owner of the higher-priority scheduled event or event request or from a neutral third-party. The same priority policy may dictate that for cases where a medium-range priority disparity exists, the lower-priority scheduled event or event request may be scheduled in conflict with the higher-priority scheduled event or event request only with the consent of the owner of the higher-priority scheduled event or event request. Finally, the priority policy may dictate that for cases where a high priority disparity exists, the lower-priority scheduled event or event request will be completely barred from being scheduled in conflict with the higher-priority event or event request. This policy is only one of many potential policies that combine the constraints shown in FIGS. 5A-5C.

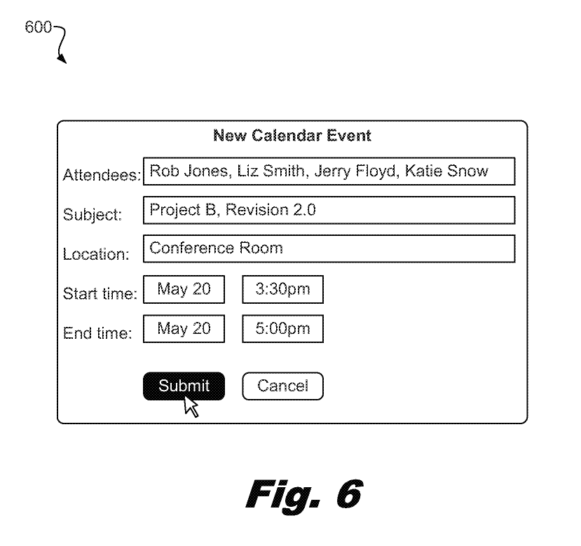

Referring now to FIG. 6, an illustrative window (600) in an illustrative computerized calendaring system consistent with the present specification is shown. In the window, a user is permitted to create a request for a new event with a designated location, designated attendees, a designated location, and a designated time and date. By clicking on the “Submit” button shown in the window, a user may submit a new event request to the computerized calendaring system.

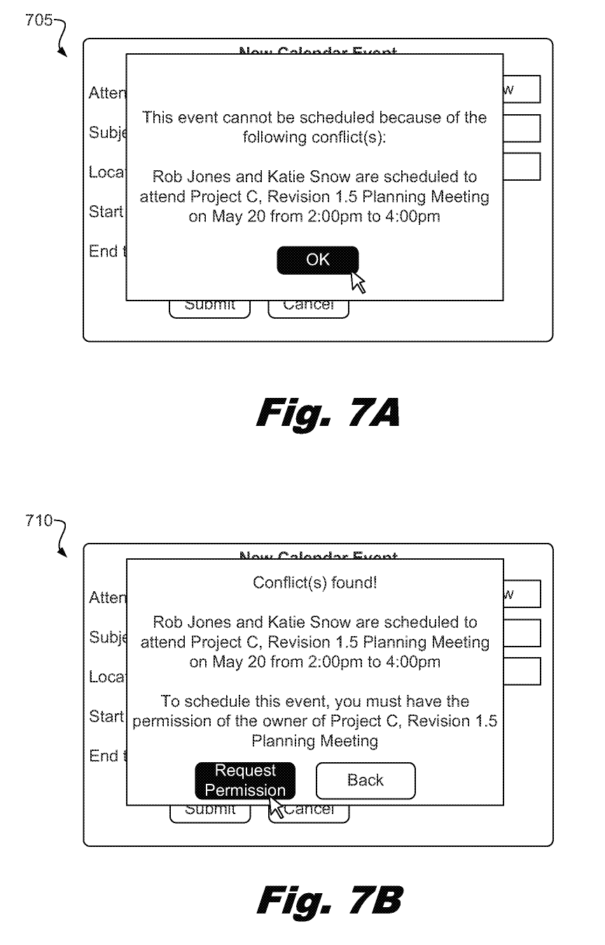

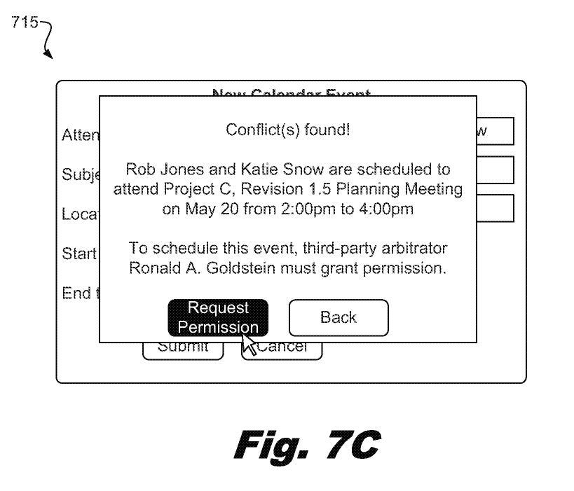

Referring now to FIGS. 7A-7C, various illustrative windows (705, 710, 715) of an illustrative user interface of an illustrative computerized calendaring system are shown, with each illustrative window (705, 710, 715) demonstrating the enforcement of a different constraint by the computerized calendaring system in response to a determination that the proposed new event conflicts with a higher-priority event.

FIG. 7A shows an illustrative window (705) in which the user is notified of the conflict and prevented from scheduling the conflicting event, consistent with the illustrative constraint shown in FIG. 6A. FIG. 7B shows an illustrative window (710) in which the user is notified of the conflict and given the option to either request the consent of an owner of a conflicting higher-priority event or return to the previous window to edit the event request, consistent with the illustrative constraint process shown in FIG. 6B. FIG. 7C shows an illustrative window (715) in which the user is notified of the conflict and given the option to either request the consent of a third-party neutral or return to the previous window to edit the event request, consistent with the illustrative constraint process shown in FIG. 6C.

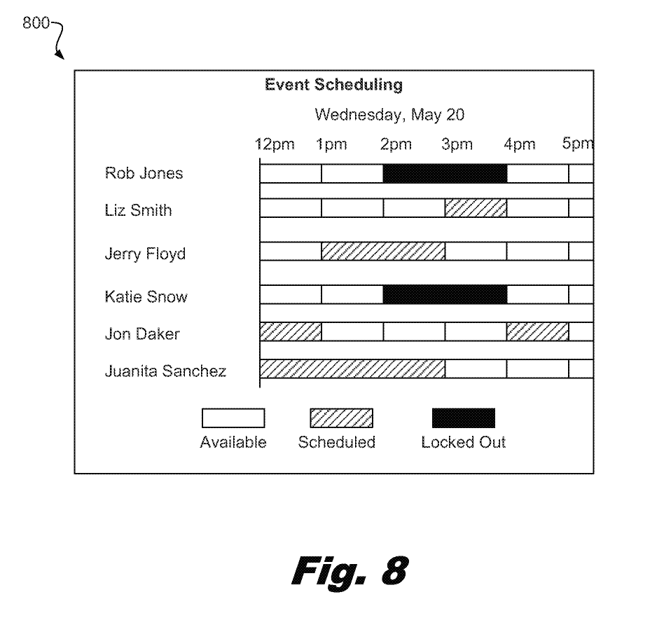

FIG. 8 shows an illustrative user interface window (800) of a computerized calendaring system that provides a scheduling utility to a user attempting to request the scheduling of a new event in the computerized calendaring system. The scheduling utility allows the user to select a number of potential attendees to an event and view the availability of each of those attendees for a certain date and time block. Additionally, the scheduling utility graphically shows for each hour block of a given day whether a particular potential attendee is available, scheduled for another event, or “locked out.” The “locked out” graphic indicates times during which the potential attendee is scheduled for another event which preempts the new event under priority considerations such that the user is barred from inviting or scheduling the potential attendee to a conflicting event, consistent with the principles described herein. Though not shown in FIG. 8, the scheduling utility may additionally or alternatively graphically display time blocks for which another specific constraint applies (e.g., time blocks for which the user will have to seek permission before scheduling a conflicting event) or for which any constraint applies. Thus, the computerized calendaring system described herein may make a determination that a tentative new event will have a lower priority than a conflicting existing event even before a request to schedule the tentative new event is formally submitted to the computerized calendaring system. By graphically indicating what constraints may be imposed on scheduling such a new event, the computerized calendaring system may facilitate the creation of new events while minimizing the need to impose constraints on scheduling the new events.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims.

What is claimed is:

1. A method of conflict resolution in a computerized calendaring system executed by a processor, said method comprising:
with said processor, receiving a request to schedule a new event that conflicts with a previously scheduled event;
determining with said processor that said previously scheduled event has priority over said new event based on historical event data; and
imposing with said processor a constraint on scheduling said new event according to a defined priority policy.

2. The method of claim 1, wherein imposing said constraint comprises preventing said new event from being scheduled in conflict with said previously scheduled event.

3. The method of claim 1, wherein imposing said constraint comprises scheduling said new event in conflict with said previously scheduled event if an owner of said previously scheduled event consents to said scheduling of said new event in conflict with said previously scheduled event.

4. The method of claim 3, further comprising:
transmitting with said processor a conflict notification to said owner of said previously scheduled event; and
soliciting said owner to consent to said scheduling of said new event in conflict with said previously scheduled event through said electronic notification.

5. The method of claim I, wherein imposing said constraint comprises scheduling said new event in conflict with said previously scheduled if a third party arbitrator consents to said scheduling of said new event in conflict with said previously scheduled event.

6. The method of claim 5, further comprising requesting consent from said third party arbitrator only if an owner of said previously scheduled event does not consent to said scheduling of said new event in conflict with said previously scheduled event.

7. The method of claim 1, wherein said previously scheduled event is a recurring event and said historical event data comprises data corresponding to past occurrences of said previously scheduled event.

8. The method of claim 7, wherein said data corresponding to past occurrences of said previously scheduled event comprises a number of times said previously scheduled event has been previously held.

9. The method of claim 7, wherein said historical event data comprises historical attendance data for said previously scheduled event.

10. The method of claim 7, wherein said determining with said processor that said previously scheduled event has priority over said new event based on historical event data comprises determining that said previously scheduled event has priority over said new event based on a determined historical precedent associated with past occurrences of said previously scheduled event.

11. The method of claim 1, wherein said historical event data comprises attendance data corresponding to an attendee associated with at least one of said new event and said previously scheduled event.

12. The method of claim 1, wherein said determining with said processor that said previously scheduled event has priority over said new event based on historical event data comprises determining that said previously scheduled event has a higher likelihood of success than said new event.

13. A method of conflict resolution in a computerized calendaring system executed by a processor, said method comprising:
with said processor, determining that a first future event and a second future event share a common time period and a common tentative attendee;
determining with said processor that said first future event has priority to said common attendee for said common time period based on historical event data; and
imposing a constraint on scheduling said common attendee for said second future event according to a defined priority policy.

14. The method of claim 13, wherein imposing said constraint comprises preventing said common attendee from being scheduled for said second future event during said common time period.

15. The method of claim 13, wherein imposing said constraint comprises permitting said common attendee to be scheduled for said second future event during said common time period if an owner of said first future event consents to said scheduling of said common attendee for said second future event during said common time period.

16. The method of claim 15, further comprising:
transmitting with said processor a conflict notification to said owner of said first future event; and
soliciting said owner of said first future event to consent to said scheduling of said common attendee for said second future event during said common time period through said electronic notification.

17. The method of claim 13, wherein imposing said constraint comprises permitting said common attendee to be scheduled for said second future event during said common time period if a third party arbitrator consents to said scheduling of said common attendee for said second future event during said common time period.

18. The method of claim 17, further comprising requesting consent from said third party arbitrator only if an owner of said first future event does not consent to said scheduling of said common attendee for said second future event during said common time period.

19. The method of claim 13, wherein said first future event is a recurring event and said historical event data comprises data corresponding to past occurrences of said first future event.

20. The method of claim 19, wherein said determining with said processor that said first future event has priority to said common attendee for said common time period based on historical event data comprises determining that said first future event has priority over said second future event based on a detected precedential pattern associated with past occurrences of said first future event.

21. The method of claim 13, wherein said determining with said processor that said first future event has priority to said common attendee for said common time period based on historical event data comprises determining that said first future event has a higher likelihood of success than said second future event.

22. A system, comprising:
a processor; and
a memory communicatively coupled to said processor; said memory comprising executable code stored thereon such that said processor, upon executing said executable code is configured to:
receive a request to schedule a new event that conflicts with a previously scheduled event;
determine that said previously scheduled event has priority over said new event based on historical event data; and
impose a constraint on scheduling said new event according to a defined priority policy.

23. The system of claim 22, wherein imposing said constraint comprises preventing said new event from being scheduled in conflict with said previously scheduled event.

24. The system of claim 22, wherein imposing said constraint comprises scheduling said new event in conflict with said previously scheduled event if an owner of said previously scheduled event consents to said scheduling of said new event in conflict with said previously scheduled event.

25. A computer program product for conflict resolution in a computerized calendaring system, comprising:
a computer readable storage medium having computer readable program code embodied therewith, the computer readable program code comprising:
computer readable program code configured to receive a request to schedule a new event that conflicts with a previously scheduled event;
computer readable program code configured to determine that said previously scheduled event has priority over said new event based on historical event data; and
computer readable program code configured to impose a constraint on scheduling said new event according to a defined priority policy.
